(19) United States
(12) Patent Application Publication
(10) Pub. No.: US 2006/0202681 A1
(43) Pub. Date: Sep. 14, 2006

(54) MAGNETIC ENCODER AND SIGNAL PROCESSING CIRCUIT FOR THE MAGNETIC ENCODER

(75) Inventor: Shigeru SHOJI, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/276,375

(22) Filed: Feb. 27, 2006

(30) Foreign Application Priority Data
Mar. 9, 2005 (JP) 2005-065165

(51) Int. Cl. G01B 7/14

(52) U.S. Cl. 324/207.13

(57) ABSTRACT

A magnetic encoder includes a magnetic medium, at least three magnetic sensor elements opposed to the magnetic medium and sequentially arranged within a range equal to or shorter than a magnetized pitch or magnetized pitches of the magnetic medium, along a relative movement direction with respect to the magnetic medium, and a signal processing circuit receiving output signals from the at least three magnetic sensor elements. The signal processing circuit includes an input unit for detecting logical states of the output signals received from the at least three magnetic sensor elements and for generating a sequence of state-detection signals arranged in the order of the at least three magnetic sensor elements, and a judgment unit for judging that the output signals received are correct output signals only when the state-detection signal sequence generated agrees with either of two expected state-detection signal sequences.

### PRIORITY CLAIM

This application claims priority from Japanese patent application No. 2005-065165, filed on Mar. 9, 2005, which is incorporated herein by reference.

### BACKGROUND OF THE INVENTION

1. Field of the Invention

The present invention relates to a magnetic encoder provided with three or more magnetic sensor elements and to a signal processing circuit for the magnetic encoder.

2. Description of the Related Art

Japanese patent publication No. 10-160511A discloses a typical magnetic encoder used for position detection, displacement detection or rotation detection. This encoder has a magnetic medium with a certain magnetization pattern formed by the horizontal magnetization recording method, and a magnetic sensor with magnetoresistive effect (MR) elements each having a sensing plane in parallel with the surface of the magnetic medium to sense a plane direction or horizontal direction component of the horizontally recorded magnetic field from the magnetic medium.

In order to improve accuracy or resolution of position detection in such magnetic encoder, it is necessary to more lessen a magnetized pitch of the magnetic medium.

However, the narrower the magnetized pitch of the magnetic medium, the more cancellation of the magnetic field between the neighbor magnetized parts of the magnetic medium occurs, and thus no magnetic field signal will be provided to a location far from the magnetic medium surface. Also, when a separation distance or gap distance between the magnetic medium and the magnetic sensor element slightly increases, the detection signal from the magnetic sensor element abruptly decreases causing an error in position detection to occur. Therefore, it is required to bring the magnetic sensor element as nearer as possible to the magnetic medium. However, the narrower the gap distance between the magnetic sensor element and the magnetic medium, the more mechanical damages of both of the magnetic sensor element and the magnetic medium due to their contact easily occurs. As aforementioned, in order to perform high-resolution detection with the magnetic encoder, it is necessary to bring the magnetic sensor element extremely nearer to the magnetic medium or to make the magnetic sensor element in contact with the magnetic medium. However, because such arrangement causes problem in durability of the magnetic sensor element and the magnetic medium, it is quite difficult to provide a magnetic encoder with high-resolution and high-durability.

U.S. Pat. No. 4,594,548 and Japanese patent publication No. 2000-105134A2 disclose a two-phase rotational magnetic encoder with magnetic sensor elements arranged to have spacing of λ/4 between adjacent elements, where λ is a magnetized pitch of the magnetic medium. According to such rotational magnetic encoder, the number of output pulses per one revolution of the magnetic medium can be increased without changing the magnetized pitch λ.

Also, as disclosed in U.S. Pat. No. 4,594,548 and Japanese patent publication No. 2000-105134A2, it is possible to widen the magnetized pitch of the magnetic medium with keeping the high-resolution if the magnetic sensor elements are arranged to have spacing between adjacent elements narrower than the magnetized pitch of the magnetic medium. As a result, a magnetic field signal will be provided to a location far from the magnetic medium and therefore the gap distance between the magnetic sensor element and the magnetic medium can be increased.

However, if the separation distance between the magnetic sensor element and the magnetic medium is increased, the output signal from the magnetic sensor element is susceptible to external noises causing an error in position detection to occur.

### SUMMARY OF THE INVENTION

It is therefore an object of the present invention to provide a magnetic encoder and a signal processing circuit for the magnetic encoder, being hardly susceptible to external noises.

Another object of the present invention is to provide a magnetic encoder and a signal processing circuit for the magnetic encoder, having a high-reliability and a high-resolution for performing precise position detection.

According to the present invention, a magnetic encoder includes a magnetic medium, at least three magnetic sensor elements opposed to the magnetic medium and sequentially arranged within a range equal to or shorter than a magnetized pitch or magnetized pitches of the magnetic medium, along a relative movement direction with respect to the magnetic medium, and a signal processing circuit receiving output signals from the at least three magnetic sensor elements. The signal processing circuit includes an input unit for detecting logical states of the output signals received from the at least three magnetic sensor elements and for generating a state-detection signal sequence with state-detection signals arranged in the order of the at least three magnetic sensor elements, and a judgment unit for judging that the output signals received are correct output signals only when the state-detection signal sequence generated agrees with either of two expected state-detection signal sequences.

According to the present invention, also, a signal processing circuit for a magnetic encoder, receiving output signals from at least three magnetic sensor elements opposed to a magnetic medium and sequentially arranged within a range equal to or shorter than a magnetized pitch or magnetized pitches of the magnetic medium, along a relative movement direction with respect to the magnetic medium, includes an input unit for detecting logical states of the output signals received from the at least three magnetic sensor elements and for generating a state-detection signal sequence with state-detection signals arranged in the order of the at least three magnetic sensor elements, and a judgment unit for judging that the output signals received are correct output signals only when the state-detection signal sequence generated agrees with either of two expected state-detection signal sequences.

Only when the state-detection signal sequence consisting of state-detection signals arranged in the order of the at least three magnetic sensor elements agrees with either of two expected state-detection signal sequences, it is judged that the output signals received are correct output signals. Thus, it is possible to eliminate an influence of external noises from the detected signals and therefore a magnetic encoder with high resistance to the external noises can be provided. Further, at least three magnetic sensor elements are sequentially arranged within a distance range equal to or shorter than a magnetized pitch or magnetized pitches of the magnetic medium. Thus, it is possible to widen the magnetized pitch or magnetized pitches of the magnetic medium without lowering the resolution of position detection. Also, it is possible to provide the magnetic field signal to a location far from the magnetic medium and therefore the gap distance or separation distance between the magnetic sensor elements and the magnetic medium can be increased. As a result, a magnetic encoder with a high-reliability and a high-resolution for performing precise position detection can be provided.

It is preferred that the signal processing circuit further includes a trigger signal generation unit for generating a trigger signal at the time when a reversal of each output signal from the at least three magnetic sensor elements occurs.

It is also preferred that the input unit includes a latch unit for detecting logical states of the output signals received from the at least three magnetic sensor elements when the trigger signal is applied and for temporarily holding the logical states detected. This input unit, preferably, includes a unit for sorting the logical states detected held in the latch unit to form the state-detection signal sequence with state-detection signals arranged in the order of the at least three magnetic sensor elements.

It is further preferred that the judgment unit includes a calculation unit for calculating two expected state-detection signal sequences to be used next time from the state-detection signal sequence corresponding to current correct output signals. More preferably, this calculation unit includes a unit for incrementing or decrementing the state-detection signal sequence corresponding to the current correct output signals by one to obtain the two expected state-detection signal sequences to be used next time.

It is still further preferred that the signal processing circuit further includes a counter unit for performing up or down count only when it is judged that the output signals received are correct output signals. More preferably, this counter unit includes an up-down counter counted in either an up direction or a down direction depending upon which one of the two expected state-detection signal sequences to be used next time is agreed with the state-detection signal sequence generated.

It is preferred that the magnetized pitch of the magnetic medium is uniform.

It is also preferred that the magnetized pitches of the magnetic medium are different with each other.

It is further preferred that the at least three magnetic sensor elements are arranged with a uniform space.

It is also preferred that a part of the at least three magnetic sensor elements are arranged with different spaces.

It is preferred that each magnetic sensor element is at least one MR element. In this case, the at least one MR element may be at least one giant magnetoresistive effect (GMR) element or at least one tunnel magnetoresistive effect (TMR) element.

Further objects and advantages of the present invention will be apparent from the following description of the preferred embodiments of the invention as illustrated in the accompanying drawings.

### BRIEF DESCRIPTION OF THE DRAWINGS

FIG. 1 shows an oblique view schematically illustrating a configuration of a magnetic encoder as a preferred embodiment according to the present invention;

FIGS. 2a and 2b show an oblique view and an exploded oblique view schematically illustrating a structure of a magnetic sensor assembly of the embodiment shown in FIG. 1;

FIGS. 3a and 3b show an oblique view and a side view schematically illustrating a positioning relation between a magnetic media and magnetic sensor elements in a magnetic sensor chip of the embodiment shown in FIG. 1, and FIG. 3c shows an enlarged oblique view schematically illustrating a configuration of the magnetic sensor element;

FIG. 4 shows a block diagram schematically illustrating a circuit configuration of a signal processing circuit of the embodiment shown in FIG. 1;

FIGS. 5a and 5b show views illustrating wave shapes and logical state of rectangular wave signals corresponding to detection outputs form the magnetic sensor elements;

FIG. 6 shows a flow chart illustrating an interrupt routine of a computer shown in FIG. 3;

FIGS. 7a and 7b show views illustrating relationships between a magnetized pitch of the magnetic medium and a distribution of the magnetic field from the magnetic medium;

FIG. 8 shows a graph illustrating a magnetic field intensity with respect to a gap distance when the magnetized pitch is changed;

FIG. 9a shows a side view schematically illustrating a positioning relation between a magnetic media and magnetic sensor elements in a magnetic sensor chip of another embodiment according to the present invention, and FIG. 9b shows a circuit diagram illustrating a connection configuration of the magnetic sensor elements; and

FIG. 10a shows a side view schematically illustrating a positioning relation between a magnetic media and magnetic sensor elements in a magnetic sensor chip of further embodiment according to the present invention, and FIGS. 10b and 10c show views illustrating wave shapes and logical state of rectangular wave signals corresponding to detection outputs form the magnetic sensor elements.

### DESCRIPTION OF THE PREFERRED EMBODIMENTS

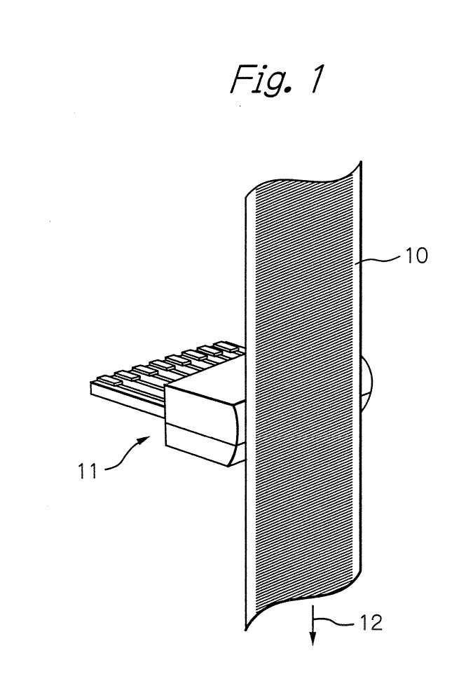

FIG. 1 schematically illustrates a configuration of a magnetic encoder as a preferred embodiment according to the present invention.

In the figure, reference numeral 10 denotes a magnetic medium to which a magnetic pattern with a predetermined magnetized pitch λ is recorded, and 11 denotes a magnetic sensor assembly with a sliding surface faced to and kept close to the magnetic medium 10, respectively.

In this embodiment, the magnetic medium 10 is fixed to a surface of an object (not shown) of which position or angle and movement directions or rotation directions are to be detected. During operation, the magnetic sensor assembly 11 is held at rest with keeping close to the surface of the magnetic medium 10. The magnetic medium 10 relatively moves with respect to the magnetic sensor assembly 11 in a direction and/or the opposite direction of an arrow 12. As for the magnetic medium, any configuration such as a flat-shaped magnetic medium, a rotating drum-shaped magnetic medium and a rotating disk-shaped magnetic medium other than the tape-shaped magnetic medium shown in the figure can be adopted.

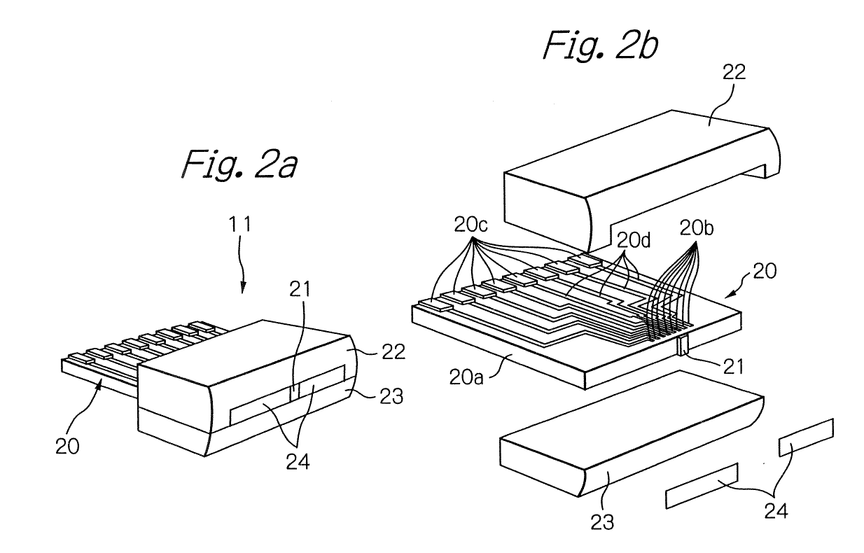

FIGS. 2a and 2b schematically illustrate the structure of the magnetic sensor assembly 11.

As shown in the figures, the magnetic sensor assembly 11 mainly consists of a printed circuit board 20, a magnetic sensor chip 21 fixed to the center of a front end surface of the printed circuit board 20, an upper housing 22 and a lower housing 23 vertically sandwiching the printed circuit board 20, and coating films 24 covering the front end surface of the printed circuit board 20 except for a section of the magnetic sensor chip 21.

The printed circuit board 20 is constituted by a substrate 20a made of for example epoxy resin, sensor-connection pads 20b formed on the substrate 20a and wire-bonded to respective electrode terminals of the magnetic sensor chip 21, external connection pads 20c formed on the substrate 20a, and connection conductors 20d formed on the substrate 20a and electrically connected between the sensor-connection pads 20b and the external connection pads 20c, respectively.

The upper and lower housings 22 and 23 are made of in this embodiment a metal material or a ceramic material.

The coating films 24 are formed by in this embodiment molding a resin.

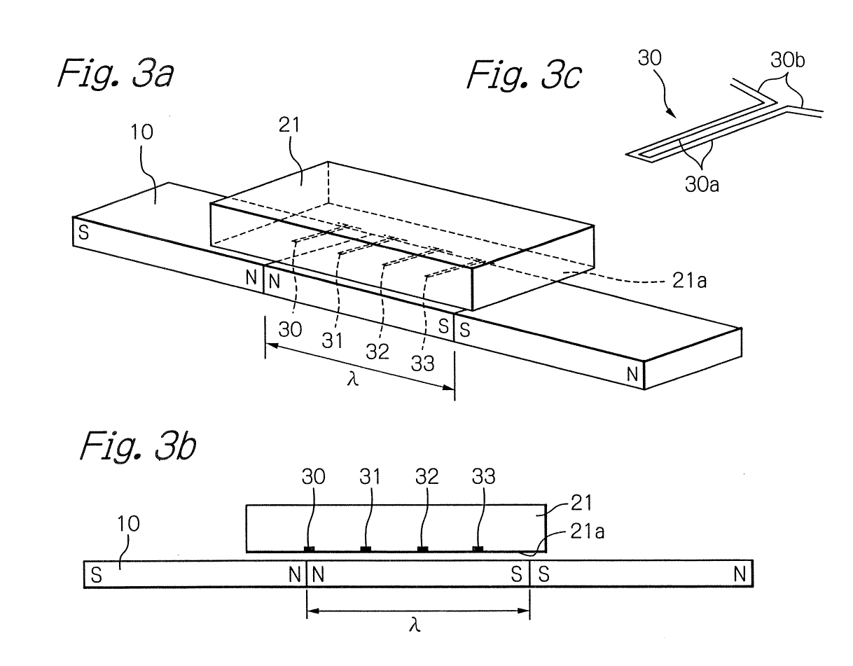

FIGS. 3a and 3b schematically illustrate a positioning relation between the magnetic media 10 and magnetic sensor elements in the magnetic sensor chip 21 of the embodiment shown in FIG. 1, and FIG. 3c schematically illustrates a configuration of the magnetic sensor element.

As shown in FIGS. 3a and 3b, in this embodiment, the magnetic sensor chip 21 has four magnetic sensor elements 30-33 formed on its surface 21a opposed to the magnetic medium 10. These four magnetic sensor elements 30-33 are spaced uniformly within a length of the magnetized pitch λ of the magnetic medium 10 along a relative movement direction between the sensor chip 21 and the magnetic medium 10. Namely, the spacing of these magnetic sensor elements 30-33 is determined equal to or shorter than λ/4.

As will be apparent from FIG. 3c, the magnetic sensor element, for example, the magnetic sensor element 30 is composed of a strip-shaped MR element 30a formed on the magnetic medium-opposing surface 21a of the magnetic sensor chip 21 and provided with two linear sections folded over at their top ends to have a U-shape, and lead conductors 30b electrically connected to both ends of the MR element 30a. The lead conductors 30b are electrically connected by wire-bonding to sensor connection pads 20b shown in FIG. 2b via signal output terminals or electrode terminals (not shown), a Vcc terminal and a ground terminal. This MR element 30a itself is constituted by a multilayered GMR element or TMR element. Each of the remaining magnetic sensor elements 31-33 has the same configuration as that of the sensor element 30.

In order to obtain sufficiently large output and high sensitivity, it is required to have enough length for each MR element. However, if the MR element is extended along the magnetic medium-opposing surface 21a without folding, an influence of the azimuth angle may be appeared. To avoid this influence, therefore, the MR element is folded back as in this embodiment. The number of folding-back is not limited to one as in this embodiment but two or more may be adopted. In other words, each MR element may be formed to have three or more linear sections connected with each other by folding-back.

Each MR element is not exposed to the magnetic medium-opposing surface 21a but located in a rearward position slightly apart from the magnetic medium-opposing surface 21a. On a surface of each MR element faced to the magnetic medium-opposing surface 21a, a protection layer made of an insulation material is formed.

The MR elements of the magnetic sensor elements 30-33 are arranged to run along a direction substantially perpendicular to the relative movement direction of the magnetic sensor assembly 11 with respect to the magnetic medium 10 (FIG. 1) or substantially perpendicular to a pitch direction of the magnetic medium 10. Thus, the four magnetic sensor elements 30-33 can detect in four-phases a horizontal magnetic field from the magnetic medium 10.

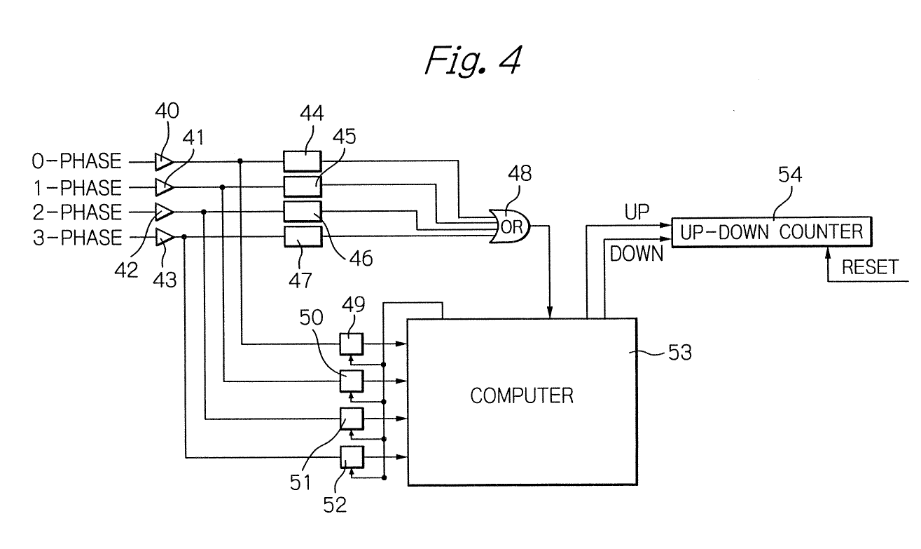

FIG. 4 schematically illustrates a circuit configuration of a signal processing circuit in this embodiment.

In the figure, reference numerals 40-43 denote amplifiers for zero-cross detecting the four-phase output signals from the four magnetic sensor elements 30-33 and for amplifying the output signals to provide rectangular wave signals respectively, 44-47 denote edge-detection circuits for respectively detecting rising edges and falling edges of the rectangular wave signals provided from the amplifiers 40-43, 48 denotes an OR circuit providing a logical OR of the output signals from the edge-detection circuits 44-47, 49-52 denote latch circuits for temporarily holding logical states of the rectangular wave signals provided from the amplifiers 40-43, 53 denotes a digital computer for performing signal processing control, and 54 denotes an up-down counter having a counted value that corresponds to a relatively moved position of the magnetic sensor assembly 11 with respect to the magnetic medium 10. In modifications, the up-down counter 54 may be realized by software stored in the computer 53. Although the signal processing circuit is formed separately from the magnetic sensor assembly in this embodiment, it may be established within the magnetic sensor assembly in modifications. The signal processing circuit may be formed on the magnetic sensor chip.

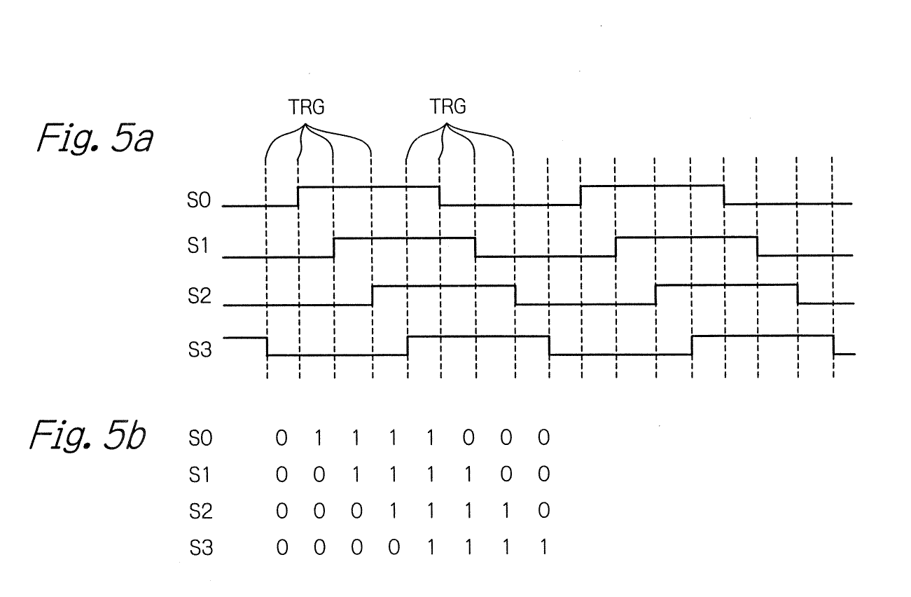

FIGS. 5a and 5b illustrate wave shapes and logical states of rectangular wave signals provided from the amplifiers.

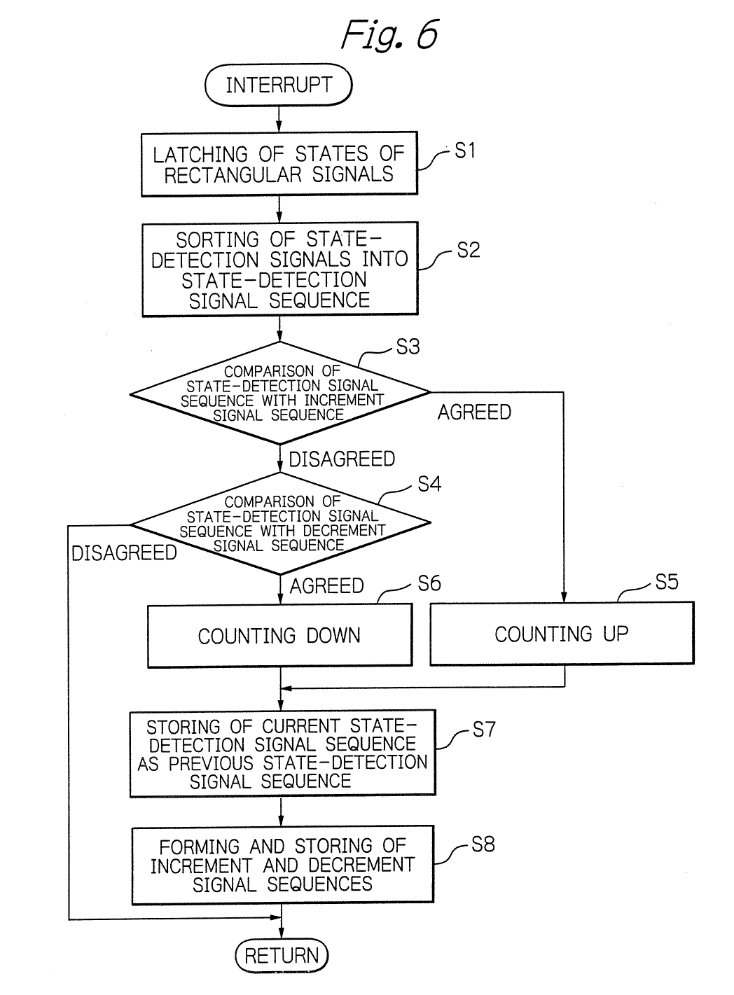

Rectangular wave signals S0-S3 shown in FIG. 5a, corresponding to the 0-3 phase output signals from the four magnetic sensor elements 30-33, are provided from the amplifiers 40-43. At every time TRG at which reversal of the rectangular wave signal occurs, a trigger signal is provided from the OR circuit 48 and applied to the computer 53 so as to start an interrupt handling operation illustrated in FIG. 6.

When receiving interrupt direction or the trigger signal, the computer 53 executes this interrupt routine.

First, the computer 53 instructs to the latch circuits 49-52 to hold the logical states of the rectangular wave signals (Step S1).

Then, the computer 53 captures the held state-detection signals from the latch circuits 49-52 and sorts them into a sequence of state-detection signals arranged in the order of the arrangement of the magnetic sensor elements 30-33 (Step S2).

FIG. 5b indicates the state-detection signal sequence corresponding respectively to logical states of the rectangular wave signals shown in FIG. 5a. As will be understood from the figure, in case of four phases, there are eight kinds of the state-detection signal sequences as “0000”, “1000”, “1100”, “1110”, “1111”, “0111”, “0011” and “0001”. The sorted namely currently obtained state-detection signal sequence should become one of them except that it is noise signals. Also, because the relative movement direction of the magnetic sensor assembly with respect to the magnetic medium is one of the frontward and backward directions, the currently obtained state-detection signal sequence should be a state-detection signal sequence derived by incrementing the previously obtained state-detection signal sequence by one (hereinafter called as increment signal sequence) or a state-detection signal sequence derived by decrementing the previously obtained state-detection signal sequence by one (hereinafter called as decrement signal sequence). For example, if the previously obtained state-detection signal sequence is “1100”, the currently obtained state-detection signal sequence should be “1110” or “1000”.

Therefore, the computer 53 compares the currently obtained state-detection signal sequence with the increment signal sequence to know whether they agree with each other or not (Step S3). If agreed, it is judged that the currently obtained state-detection signal sequence is not noise signals but a correct signal sequence and that the relative movement direction is a predetermined direction for example the forward or right direction. Then, the computer 53 increments or counts up the content in the up-down counter 54 by one (Step S5) and executes the next process at Step S7.

On the other hand, if disagreed at Step S3, the computer 53 compares the currently obtained state-detection signal sequence with the decrement signal sequence to know whether they agree with each other or not (Step S4). If disagreed, it is judged that the currently obtained state-detection signal sequence is noise signals. Then, the computer 53 finishes this interrupt routine without executing the following processes and returns to the original routine.

If agreed at Step S4, it is judged that the currently obtained state-detection signal sequence is not noise signals but a correct signal sequence and that the relative movement direction is a direction opposite to the predetermined direction for example the backward or left direction. Then, the computer 53 decrements or counts down the content in the up-down counter 54 by one (Step S6) and executes the next process at Step S7.

At Step S7, the computer 53 stores the currently obtained state-detection signal sequence as the previously obtained state-detection signal sequence.

Thereafter, the computer 53 increments this previously obtained state-detection signal sequence by one to form an increment signal sequence, decrements the previously obtained state-detection signal sequence by one to form a decrement signal sequence, and stores them for the next interrupt routine (Step S8). Then, the computer 53 finishes this interrupt routine and returns to the original routine.

Accordingly, only when the currently obtained state-detection signal sequence agrees with one of the two expected state-detection signal sequences, namely with the increment signal sequence or the decrement signal sequence, the up-down counter 54 counts up or down depending upon the agreed signal sequence. Therefore, the probability of occurrence of error in counting due to the external noises reduces to ⅜ in case of four-phase detection as this embodiment. As a result, according to this embodiment, position detection and moving direction detection with high resistance to the external noises can be expected. In case of n-phase detection (n is natural number), the probability of occurrence of error in counting due to the external noises will reduce to 3/2n. Thus, the shorter of the spacing between the sensor elements, the higher noise resistant effect can be expected.

Also, according to this embodiment, because the four magnetic sensor elements 30-33 are aligned with a uniform space P that is a space equal to or shorter than λ/4 within a length of the magnetized pitch λ of the magnetic medium 10, it is possible to widen the magnetized pitch λ of the magnetic medium 10 without lowering the resolution of position detection.

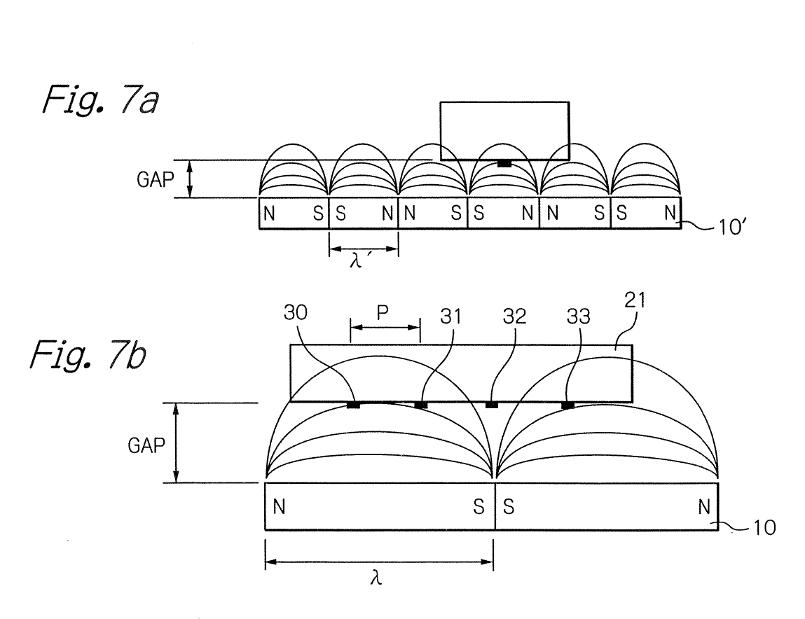

FIGS. 7a and 7b illustrate relationships between the magnetized pitch of the magnetic medium and a distribution of the magnetic field from the magnetic medium to explain this latter point. Conventionally, in order to increase the resolution of position detection, the magnetized pitch λ′ of the magnetic medium 10′ was narrowed as shown in FIG. 7a. Instead of this conventional method, if the plurality of magnetic sensor elements 30-33 are prepared and aligned within a length of the magnetized pitch λ of the magnetic medium 10 by narrowing their space P without widening the magnetized pitch λ of the magnetic medium 10 as shown in FIG. 7b, higher magnetic field intensity can be obtained even when the separation distance or gap distance GAP between the magnetic sensor elements and the magnetic medium is large.

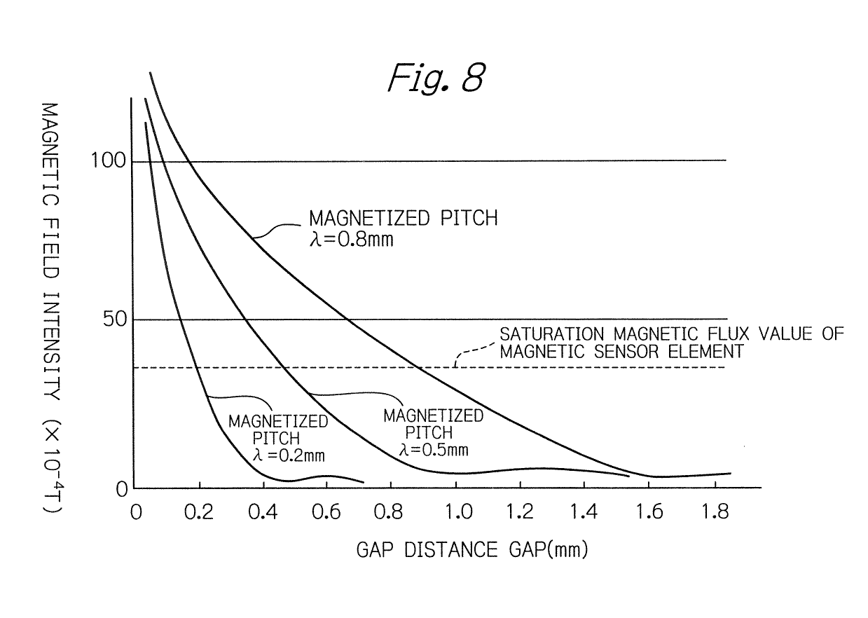

FIG. 8 illustrates magnetic field intensity with respect to gap distance when the magnetized pitch λ is changed. As will be understood from the figure, if a magnetic sensor element providing a saturation output under the environment of the magnetic field of 30-40×10⁻⁴ T (30-40 Gauss) or more is used, the similar detection response can be obtained between the case where the magnetized pitch λ is 0.2 mm and the case where the magnetized pitch λ is 0.8 mm and the gap distance GAP is 4-5 times larger than that when the magnetized pitch λ is 0.2 mm. In other words, when the same magnetic medium is used, the wider of the magnetized pitch λ, the larger of the gap distance GAP is allowed. Therefore, as in this embodiment, by arranging the four magnetic sensor elements 30-33 with the space P equal to or shorter than λ/4 within a length of the magnetized pitch λ of the magnetic medium 10, a highly-reliable magnetic encoder without sustaining damage due to contact of the magnetic sensor element and the magnetic medium while keeping high-precision in position detection can be obtained.

Also, according to this embodiment, since it is possible to provide high magnetic field intensity from the magnetic medium, an influence of variations in gap distance can be reduced. This aspect is particularly advantageous for a case wherein a magnetic medium and a magnetic sensor assembly are separately mounted on different members. Furthermore, according to the embodiment, because it is easy to obtain a saturation output from the magnetic sensor element, reliability of the encoder can be more improved.

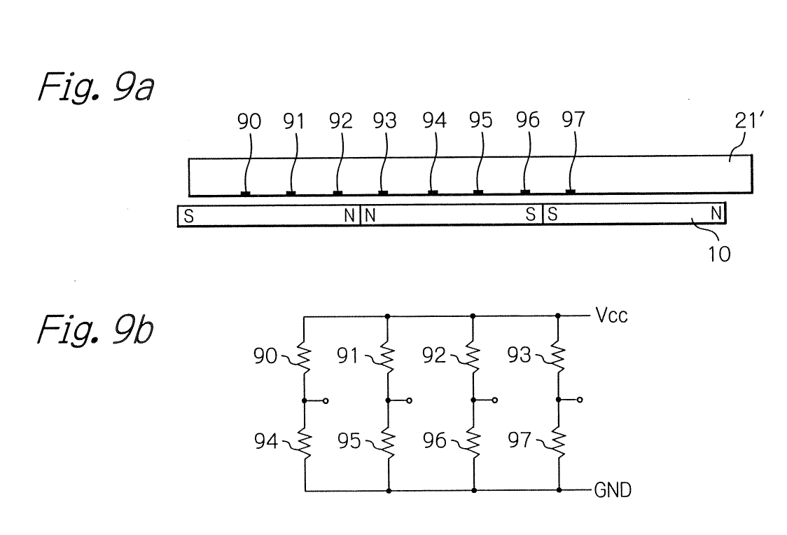

FIG. 9a schematically illustrates a positioning relation between a magnetic media and magnetic sensor elements in a magnetic sensor chip of another embodiment according to the present invention, and FIG. 9b illustrates a connection configuration of the magnetic sensor elements.

In the aforementioned embodiment of FIG. 1, the four magnetic sensor elements 30-33 are aligned in four phases with the space equal to or shorter than λ/4 as shown in FIGS. 3a and 3b. On the contrary, in this embodiment, as for a magnetic sensor chip 21′, eight magnetic sensor elements 90-97 are aligned with a uniform space equal to or shorter than λ/4 as shown in FIG. 9a. These magnetic sensor elements 90-97 are electrically connected to form a four-phase half bridge configuration. Namely, the two magnetic sensor elements 90 and 94, 91 and 95, 92 and 96, and 93 and 97, each spaced by a distance of the magnetized pitch λ, are electrically connected in series, respectively, and double outputs are derived from their middle connection points as shown in FIG. 9b.

Other configurations of the magnetic encoder in this embodiment are substantially the same as these in the embodiment of FIG. 1.

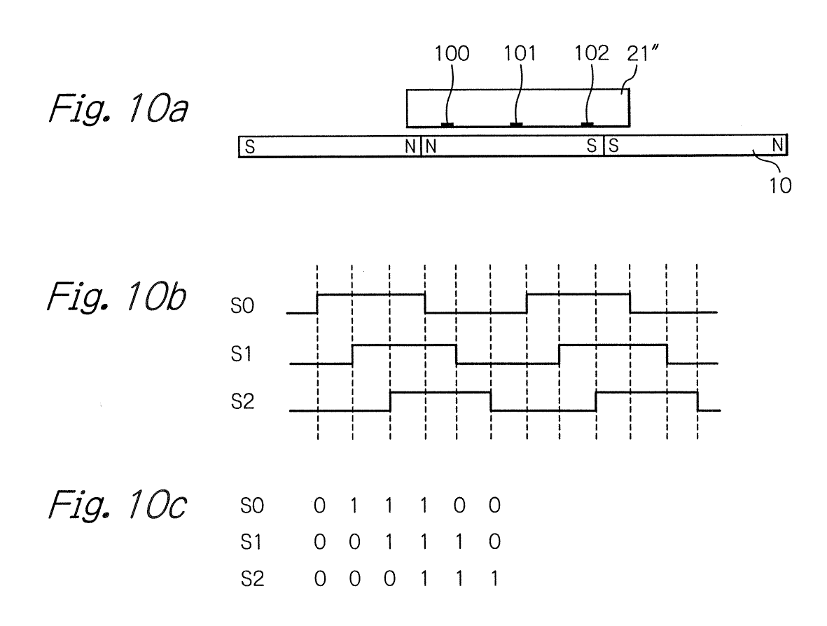

FIG. 10a schematically illustrates a positioning relation between a magnetic media and magnetic sensor elements in a magnetic sensor chip of further embodiment according to the present invention, and FIGS. 10b and 10c illustrate wave shapes and logical state of rectangular wave signals corresponding to detection outputs form the magnetic sensor elements.

In the aforementioned embodiment of FIG. 1, the four magnetic sensor elements 30-33 are aligned in four phases with the space equal to or shorter than λ/4 as shown in FIGS. 3a and 3b. On the contrary, in this embodiment, as for a magnetic sensor chip 21′′, three magnetic sensor elements 100-102 are aligned with a uniform space equal to or shorter than λ/3 as shown in FIG. 10a. Rectangular wave signals S0-S2 shown in FIG. 10b, corresponding to the 0-2 phase output signals from the three magnetic sensor elements 100-102, are provided to form a state-detection signal sequence that represents logical states of the rectangular wave signals and has the order of the arrangement of the magnetic sensor elements 100-102. FIG. 10c indicates the state-detection signal sequence corresponding respectively to the rectangular wave signals shown in FIG. 10b. As will be understood from the figure, in case of three phases, there are six kinds of the state-detection signal sequences as “000”, “100”, “110”, “111”, “011” and “001”.

Other configurations of the magnetic encoder in this embodiment are substantially the same as these in the embodiment of FIG. 1.

In the aforementioned embodiments, three or four magnetic sensor elements are arranged within a length of the magnetized pitch of the magnetic medium. However, according to the present invention, the number of the magnetic sensor elements arranged within a length of the magnetized pitch length is not limited to three or four, but may be any number higher than two. The greater of the number of the sensor elements, the higher resolution in position detection and in moving direction detection are attained. In the aforementioned embodiments, also, the magnetized pitch of the magnetic medium is a uniform pitch. However, in modifications, magnetized pitches different with each other may be used in a partial or all area of the magnetic medium. Also, in modifications, a part of or all the magnetic sensor elements may be arranged with different spaces.

Many widely different embodiments of the present invention may be constructed without departing from the spirit and scope of the present invention. It should be understood that the present invention is not limited to the specific embodiments described in the specification, except as defined in the appended claims.

1. A magnetic encoder comprising:
a magnetic medium;
at least three magnetic sensor elements opposed to said magnetic medium and sequentially arranged within a range equal to or shorter than a magnetized pitch or magnetized pitches of said magnetic medium, along a relative movement direction with respect to said magnetic medium; and
a signal processing circuit receiving output signals from said at least three magnetic sensor elements,
said signal processing circuit including input means for detecting logical states of the output signals received from said at least three magnetic sensor elements and for generating a state-detection signal sequence with state-detection signals arranged in the order of said at least three magnetic sensor elements, and judgment means for judging that the output signals received are correct output signals only when the state-detection signal sequence generated agrees with either of two expected state-detection signal sequences.

2. The magnetic encoder as claimed in claim 1, wherein said signal processing circuit further includes trigger signal generation means for generating a trigger signal at the time when a reversal of each output signal from said at least three magnetic sensor elements occurs.

3. The magnetic encoder as claimed in claim 2, wherein said input means includes latch means for detecting logical states of the output signals received from said at least three magnetic sensor elements when the trigger signal is applied and for temporarily holding the logical states detected.

4. The magnetic encoder as claimed in claim 3, wherein said input means includes means for sorting the logical states detected held in said latch means to form the state-detection signal sequence with state-detection signals arranged in the order of said at least three magnetic sensor elements.

5. The magnetic encoder as claimed in claim 1, wherein said judgment means includes calculation means for calculating two expected state-detection signal sequences to be used next time from the state-detection signal sequence corresponding to current correct output signals.

6. The magnetic encoder as claimed in claim 5, wherein said calculation means includes means for incrementing or decrementing the state-detection signal sequence corresponding to the current correct output signals by one to obtain the two expected state-detection signal sequences to be used next time.

7. The magnetic encoder as claimed in claim 1, wherein said signal processing circuit further includes counter means for performing up or down count only when it is judged that the output signals received are correct output signals.

8. The magnetic encoder as claimed in claim 7, wherein said counter means includes an up-down counter counted in either an up direction or a down direction depending upon which one of the two expected state-detection signal sequences to be used next time is agreed with the state-detection signal sequence generated.

9. The magnetic encoder as claimed in claim 1, wherein the magnetized pitch of said magnetic medium is uniform.

10. The magnetic encoder as claimed in claim 1, wherein the magnetized pitches of said magnetic medium are different with each other.

11. The magnetic encoder as claimed in claim 1, wherein said at least three magnetic sensor elements are arranged with a uniform space.

12. The magnetic encoder as claimed in claim 1, wherein a part of said at least three magnetic sensor elements are arranged with different spaces.

13. The magnetic encoder as claimed in claim 1, wherein each magnetic sensor element comprises at least one magnetoresistive effect element.

14. The magnetic encoder as claimed in claim 13, wherein said at least one magnetoresistive effect element comprises at least one giant magnetoresistive effect element or at least one tunnel magnetoresistive effect element.

15. A signal processing circuit for a magnetic encoder, said signal processing circuit receiving output signals from at least three magnetic sensor elements opposed to a magnetic medium and sequentially arranged within a range equal to or shorter than a magnetized pitch or magnetized pitches of said magnetic medium, along a relative movement direction with respect to said magnetic medium, said signal processing circuit comprising:
input means for detecting logical states of the output signals received from said at least three magnetic sensor elements and for generating a state-detection signal sequence with state-detection signals arranged in the order of said at least three magnetic sensor elements; and
judgment means for judging that the output signals received are correct output signals only when the state-detection signal sequence generated agrees with either of two expected state-detection signal sequences.

16. The signal processing circuit as claimed in claim 15, wherein said signal processing circuit further comprises trigger signal generation means for generating a trigger signal at the time when a reversal of each output signal from said at least three magnetic sensor elements occurs.

17. The signal processing circuit as claimed in claim 16, wherein said input means includes latch means for detecting logical states of the output signals received from said at least three magnetic sensor elements when the trigger signal is applied and for temporarily holding the logical states detected.

18. The signal processing circuit as claimed in claim 17, wherein said input means includes means for sorting the logical states detected held in said latch means to form the state-detection signal sequence with state-detection signals arranged in the order of said at least three magnetic sensor elements.

19. The signal processing circuit as claimed in claim 15, wherein said judgment means includes calculation means for calculating two expected state-detection signal sequences to be used next time from the state-detection signal sequence corresponding to current correct output signals.

20. The signal processing circuit as claimed in claim 19, wherein said calculation means includes means for incrementing or decrementing the state-detection signal sequence corresponding to the current correct output signals by one to obtain the two expected state-detection signal sequences to be used next time.

21. The signal processing circuit as claimed in claim 15, wherein said signal processing circuit further comprises counter means for performing up or down count only when it is judged that the output signals received are correct output signals.

22. The signal processing circuit as claimed in claim 21, wherein said counter means comprises an up-down counter counted in either an up direction or a down direction depending upon which one of the two expected state-detection signal sequences to be used next time is agreed with the state-detection signal sequence generated.
